(19) United States
(12) Patent Application Publication
(10) Pub. No.: US 2015/0074650 A1
(43) Pub. Date: Mar. 12, 2015

(54) MULTIVARIATE A/B TESTING OF MOBILE APPLICATIONS

(71) Applicant: THOMSON REUTERS GLOBAL RESOURCES

(72) Inventors: Daniel Bennett, Rosemount, MN (US); Robert J. Schukai, Marietta, GA (US)

(73) Assignee: THOMSON REUTERS GLOBAL RESOURCES

(21) Appl. No.: 14/478,131

(22) Filed: Sep. 5, 2014

Related U.S. Application Data
(60) Provisional application No. 61/874,700, filed on Sep. 6, 2013.

(51) Int. Cl. G06F 11/36

(52) U.S. Cl. CPC G06F 11/3688
USPC 717/125

(57) ABSTRACT

The present disclosure is directed towards systems and methods for multivariate testing, which comprises, in response to a request for one or more content items on an access device, identifying one or more data items associated with the access device and identifying one of a set of payloads based on the one or more data items associated with the access device. The identified payload is retrieved and the rendered on the access device.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to this document: Copyright © 2014 Thomson Reuters.

### CROSS-REFERENCE TO RELATED APPLICATION

This application claims priority to U.S. Provisional Application No. 61/874,700 filed Sep. 6, 2013, entitled “Multivariate A/B Testing of Mobile Applications,” the content of which is incorporated herein in its entirety.

### TECHNICAL FIELD

This disclosure relates generally to conversion testing and conversion rate optimization. More specifically, the disclosure is directed towards systems and methods for multivariate testing of mobile applications in order to optimize outcomes of customer interactions with those applications.

### BACKGROUND

In the United States, the mobile communications market has become quite competitive with the entrance of new virtual network operators and a diverse array of pricing options and strategies (including prepaid and postpaid phones, usage-based fees, shared plans, reduced-speed access, and even handset subsidies, financing and buy-back programs). Carriers, providers, marketers, developers and the like are thus constantly seeking new and improved ways to bring in new users or to have existing users adopt new and/or additional, preferably revenue-generating, services. This drive will become even more imperative in the future in view of the general recognition that, at some point, the rate of growth of new users in the mobile space will slow or even plateau.

As part of this challenge, carriers, providers, marketers and developers seek to maximize the impact their services and offerings have on current or potential new users. A common challenge for these carriers, providers and their user interface (UI) designers and developers, is determining which variation of a design or message will be most compelling for customers. While in-person, qualitative testing might provide the most accurate metric, adoption of such tests on a large-scale can be cost and time prohibitive. Alternatively, performance of such testing on a smaller scale is typically of such an insufficient sample size as to be able to drive relevant enhancements.

In response to such challenges, an increase in web-based A/B and multivariate testing with numerous commercial solutions for testing direct mail and website configurations has been observed in the last several years. Today, there are numerous commercial products for direct mail and web site testing (typically covering test configuration, trial rate, response measurement and reporting). Although generally led by marketing groups as a way of optimizing marketing spend, multivariate testing is increasingly being used to test user experience designs.

As generally known, A/B testing (or split testing) is a method of website optimization where live traffic is driven to differing versions of a web page or email (version A and version B) and then monitored for the way the user interacts with his/her version of the page. The ‘attractiveness’ or conversion rate (i.e., the proportion of users who take an action that is beyond a casual content view or website visit—e.g., click-throughs, registrations, videos watched, successful completion of a checkout process) for that component is then inferred by response. Analysis of this interaction can help the web-page owner/developer/designer/marketer determine which page is more effective. Multivariate testing uses a similar core mechanism as A/B testing, but includes a higher number of variables and reveals more information about how each of these variables interact. Thus, more detailed information is revealed as to the effectiveness of individual components or elements of the web page or email being tested.

Existing web-based approaches for split and multivariate testing, however, often do not provide support for mobile web-based applications and, even in those instances where they do, significant experimentation and substantial rework is still needed in order that they be made applicable to a small screen. Further, these web-based solutions are insufficiently adaptable for robust testing of mobile applications existing in a mobile environment.

Accordingly, a multivariate platform-agnostic testing platform for mobile applications that helps carriers, providers, marketers, and developers optimize the engagement of customers, potential customers and other users with these applications is needed. This, in turn, is expected to help accelerate product development, drive new customer and revenue growth, increase customer retention, and/or further the adoption of new and/or additional revenue-generating products, services and solutions.

### SUMMARY

The present disclosure is directed towards systems and methods for multivariate testing. In one aspect, the method includes, in response to a request for one or more content items on an access device, identifying one or more data items associated with the access device and identifying one of a set of payloads based on the one or more data items associated with the access device. The identified payload is then retrieved and rendered on the access device.

In one embodiment, the method further comprises collecting one or more test results in response to an interaction with the access device. In another embodiment, the method further comprises determining whether the access device is in an on-line mode or an off-line mode. When in an on-line mode, the set of payloads further comprises one or more test payloads and the identified payload is retrieved from a remote server. By contrast, when the access device is in an off-line mode, the set of payloads further comprises one or more default payloads and the identified default payload is retrieved from the access device.

According to one embodiment, the one or more data items associated with the access device are collected from one or more sensors of the access device. The one or more data items associated with the access device may comprise at least one of an access device type, an access device manufacturer, an access device model, a network connection type, a date, a time, an access device orientation, an access device location, an access device display size, an access device position, an ambient temperature, an ambient lighting, an ambient humidity, an ambient pressure, a battery level, an audio input capability, an image/video input capability, a device brightness, a magnetic field, a display text size, and a biometric capability.

A system, as well as articles that include a machine-readable medium storing machine-readable program code for implementing the various techniques, are disclosed. Details of various embodiments are discussed in greater detail below.

Additional features and advantages will be readily apparent from the following detailed description, the accompanying drawings and the claims.

### BRIEF DESCRIPTION OF THE DRAWINGS

FIG. 1 is a schematic depicting an exemplary computer-based system for multivariate testing of mobile applications;

FIG. 2 is a flow diagram illustrating an exemplary computer-implemented method for generating one or more payloads for multivariate testing of mobile applications is disclosed.

FIG. 3 is a flow diagram illustrating an exemplary computer-implemented method for multivariate testing of mobile applications;

FIG. 4 is a flow diagram illustrating an exemplary computer-implemented method for multivariate testing of mobile applications; and

FIG. 5 is a screen diagram of an exemplary multivariate testing of a mobile application.

Like reference symbols in the various drawings indicate like elements.

### DETAILED DESCRIPTION

In the following description, reference is made to the accompanying drawings that form a part hereof, and in which is shown by way of illustration specific embodiments in which the disclosure may be practiced. It is to be understood that other embodiments may be utilized and structural changes may be made without departing from the scope of the present disclosure.

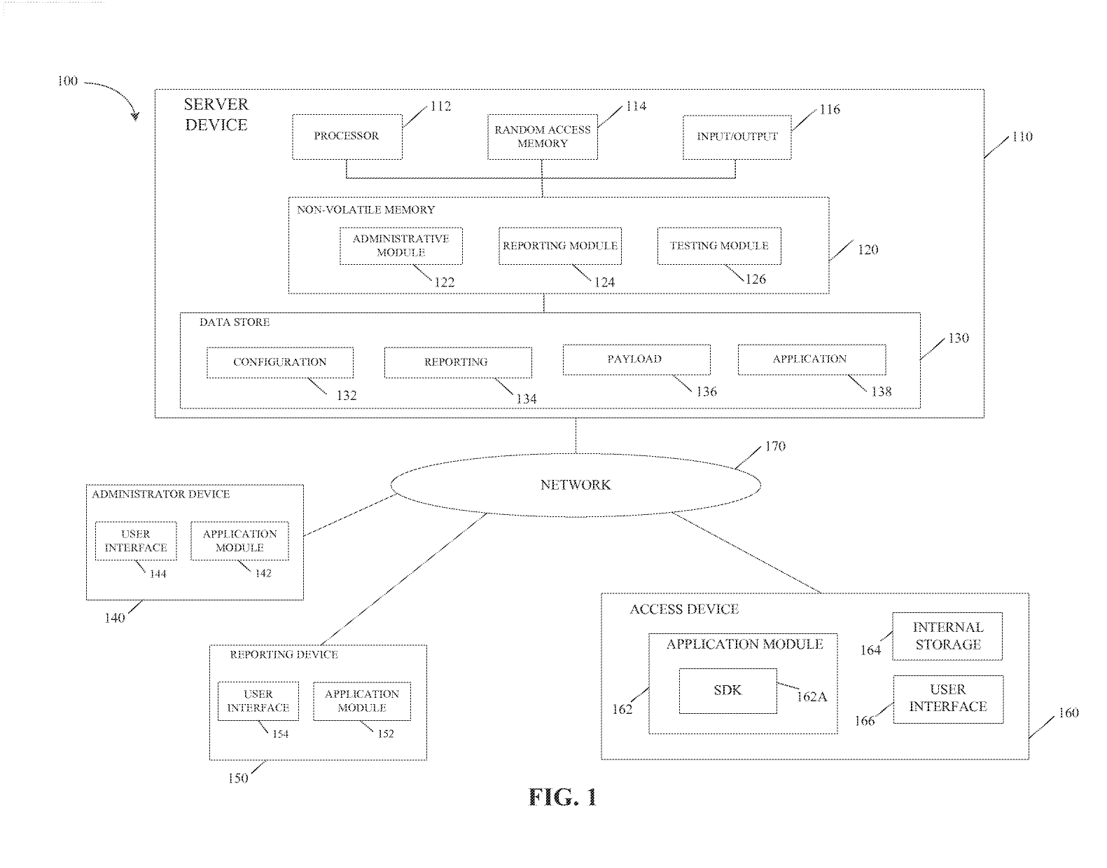

Turning now to FIG. 1, an example of a suitable computing system 100 within which embodiments of the disclosure may be implemented is presented. The computing system 100 is only one example and is not intended to suggest any limitation as to the scope of use or functionality of the disclosure. Neither should the computing system 100 be interpreted as having any dependency or requirement relating to any one or combination of illustrated components.

For example, the present disclosure is operational with numerous other general purpose or special purpose computing consumer electronics, network PCs, minicomputers, mainframe computers, laptop computers, as well as distributed computing environments that include any of the above systems or devices, and the like.

The disclosure may be described in the general context of computer-executable instructions, such as program modules, being executed by a computer. Generally, program modules include routines, programs, objects, components, data structures, loop code segments and constructs, etc. that perform particular tasks or implement particular abstract data types. The disclosure can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art can implement the description and figures as processor executable instructions, which can be written on any form of a computer readable media.

In one embodiment, with reference to FIG. 1, the system 100 includes a server device 110 configured to include a processor 112, such as a central processing unit (“CPU”), random access memory (“RAM”) 114, one or more input-output devices 116, such as a display device (not shown) and keyboard (not shown), non-volatile memory 120 and data store 130, all of which are interconnected via a common bus and controlled by the processor 112.

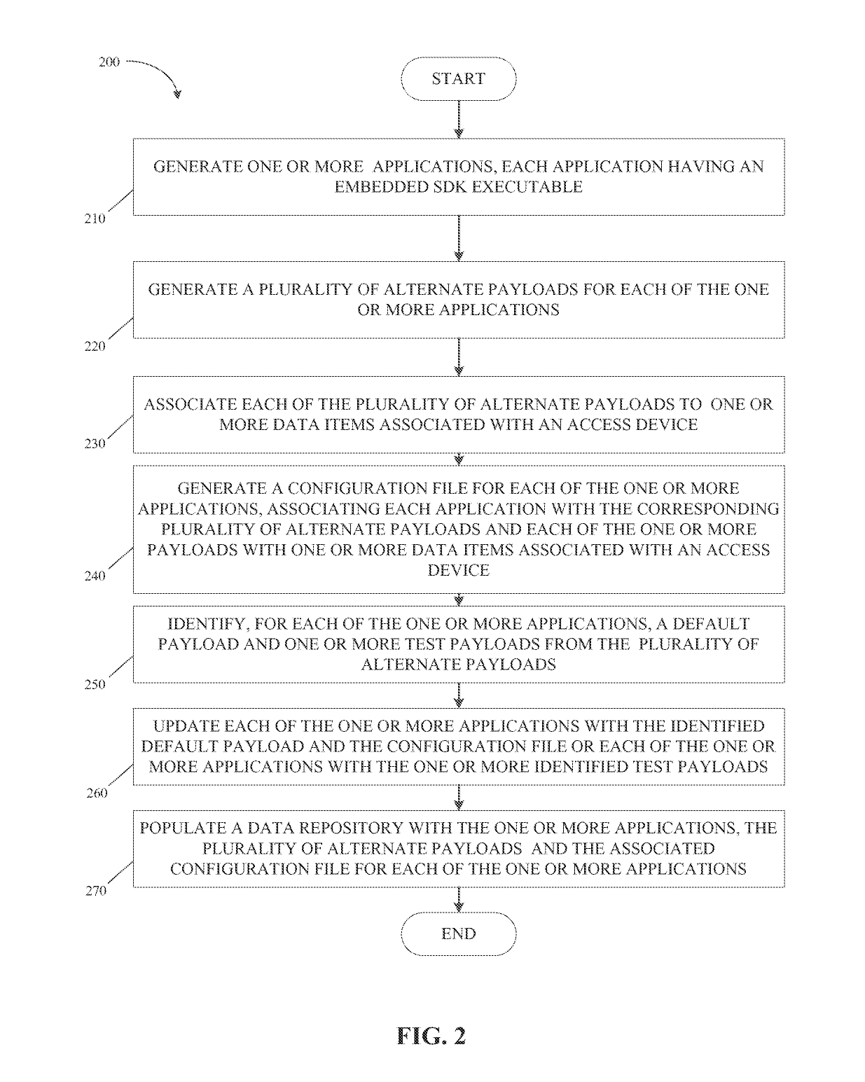

As shown in the FIG. 1 example, in one embodiment, the non-volatile memory 120 is configured to include an administration module 122, a reporting module 124 and a testing module 126. The administration module 122 is configured to generate one or more applications each having an embedded SDK executable, a plurality of alternate payloads for each of the one or more applications and configuration file for each of the one or more applications. In one embodiment, each application is associated with a corresponding plurality of alternate payloads and each of the alternate payloads is associated with one or more data items associated with an access device. The administration module 122 is further configured to update applications and configuration files as well populate the appropriate data stores of the data store 130, which will be discussed in further detail in connection with FIG. 2.

According to one embodiment, the reporting module 124 is configured to receive one or more test results from the SDK 162A and store the results in the appropriate data store of the data store 130. The reporting module 124 is further configured to serve as the gateway of the stored test results in the data store 130 to the reporting device 150. The testing module 126 is configured to determine and serve test payloads based on one or more data items associated with access device 160 using a configuration file. Additional details of modules 122, 124 and 126 are discussed in connection with FIGS. 2-5.

As shown in FIG. 1, in one embodiment, a network 170 is provided that can include various devices such as routers, server, and switching elements connected in an Intranet, Extranet or Internet configuration. In one embodiment, the network 170 employs wireless communication protocols to transfer information between an access device 160, the server device 110, the data store 130, a reporting device 150 and an administrative device 140. For example, the network 170 may be a cellular or mobile network employing digital cellular standards including but not limited to the 3GPP, 3GPP2 and AMPS family of standards such as Global System for Mobile Communications (GSM), General Packet Radio Service (GPRS), CDMAOne, CDMA2000, Evolution-Data Optimized (EV-DO), LTE Advanced, Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). The network 170 may also be a Wide Area Network (WAN), such as the Internet, which employs one or more transmission protocols, e.g. TCP/IP. As another example, the network 170 may employ a combination of digital cellular standards and transmission protocols. In another embodiment, the network 170 uses wired communications to transfer information between the access device 160, the server device 110, the data store 130, the reporting device 150 and the administrative device 140. In yet other embodiments, the network 170 may employ a combination of wired and wireless technologies to transfer information between the access device 160, the server device 110, the data store 130, the reporting device 150 and the administrative device 140.

The data store 130 is a repository that maintains and stores information utilized by the before-mentioned modules 122, 124 and 126. In one embodiment, the data store 130 is a relational data store. In another embodiment, the data store 130 is a directory server, such as a Lightweight Directory Access Protocol (“LDAP”). In yet another embodiment, the data store 130 is an area of non-volatile memory 120 of the server device 110.

In one embodiment, as shown in the FIG. 1 example, the data store 130 includes a configuration data store 132, a reporting data store 134, a payload data store 136 and an application data store 138. According to one embodiment, the configuration data store 132 includes one or more configuration files, each of which identify an application, the associated plurality of alternate payloads and the corresponding one or more data items associated with an access device. The reporting data store 134, according to one embodiment, includes one or more test results collected by the SDK 162A in response to the access device 160 interaction with a payload, such as whether the user engaged in a click-through, how long the user observed the display, whether the user accessed a link to other content, whether the user engaged is the selection of any radio buttons or drop down menus on the display. Further, according to one embodiment, the conditions under which the user interacted with a payload is stored in the reporting data store 134, such as the geographic location of the access device, the strength of the network connection for the access device, demographic information regarding the user and environmental conditions of the access device 160. The payload data store 136 and the application data store 138, in one embodiment, stores the test payloads and applications embedded with SDKs, respectively.

Although the data store 130 shown in FIG. 1 is shown as part of the server device 110, it will be appreciated by one skilled in the art that the data store 130 and/or any of the information shown therein, can be distributed across various servers and be accessible to the server device 110 over the network 150, be coupled directly to the server device 110, or be configured in an area of non-volatile memory 120 of the server device 110.

The access device 160, according to one embodiment, is a mobile device, such as a smartphone, tablet device or other personal digital assistant device, having a user interface 166, an application module 162 with a Software Development Kit executable (“SDK”) 162A and an internal storage component 164, a plurality of sensors (not shown), an external storage component (not shown), a power management system (not shown), an audio component (not shown), audio input/output components (not shown), an image capture and process system (not shown), RF antenna (not shown) and a subscriber identification module (SIM) (not shown). The internal storage component 164 may include, for example, static random-access memory (SRAM) or Flash memory components. According to another embodiment, the access device 160, is a general purpose or special purpose computing device comprising the user interface 166, the application module 162 with the SDK 162A, a plurality of sensors (not shown), a processor (not shown), transient and persistent storage devices (not shown), input/output subsystem (not shown), bus to provide a communications path between components comprising the general purpose or special purpose computer, and a web-based client application, such as a web browser, which allows a user to access the data stored within data store 130. Examples of web browsers are known in the art, such as Microsoft® Internet Explorer®, Google Chrome™, Mozilla Firefox® and Apple® Safari®. According to one embodiment, the access device 160 may comprise a plurality of access devices, each of which comprise the same exemplary components as described herein.

The application module 162, according to one embodiment, is configured to execute an application, which is rendered to a user on the user interface 166 of the access device 160. The SDK 162A, in one embodiment, is embedded within the application, executed during run time of the application and is written in the natural language of the application in which it is embedded within. For example, the SDK 162A may be written in Java for Android™ platform, Objective C for IOS® and Microsoft® .NET for Microsoft® Windows Phone® or in JavaScript for supported web-based applications. In one embodiment, the SDK 162A, upon execution of the application, connects to the testing module 126 of the server device 110 and asynchronously requests test payloads from the testing module 126 using a configuration file when the access device 160 is connected to the server device 110. Alternatively, when the access device 160 is not connected to the server device 110, the SDK 162A will request from the internal storage 164 a default payload for presentation on the access device 160.

According to one embodiment, the administrative device 140 is a general purpose or special purpose computing device comprising a user interface 144, an application module 142, transient and persistent storage devices, input/output subsystem and bus to provide a communications path between components comprising the general purpose or special purpose computer. In one embodiment, the user interface 144 allows a user to access the data stored within data store 130 thorough the use of a web-based application, such as a web browser. Examples of web browsers are those that are known in the art, such Microsoft® Internet Explorer®, Google Chrome™, Mozilla Firefox® and Apple® Safari®. Similarly, in one embodiment, the reporting device 150 is a general purpose or special purpose computing device comprising a user interface 154, an application module 152, transient and persistent storage devices, input/output subsystem and bus to provide a communications path between components comprising the general purpose or special purpose computer.

Further, it should be noted that the system 100 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input and requests are communicated to the computing device via an input device, such as a keyboard and/or mouse. Data output, such as the computed significance score, of the system is communicated from the computing device to a display device, such as a computer monitor.

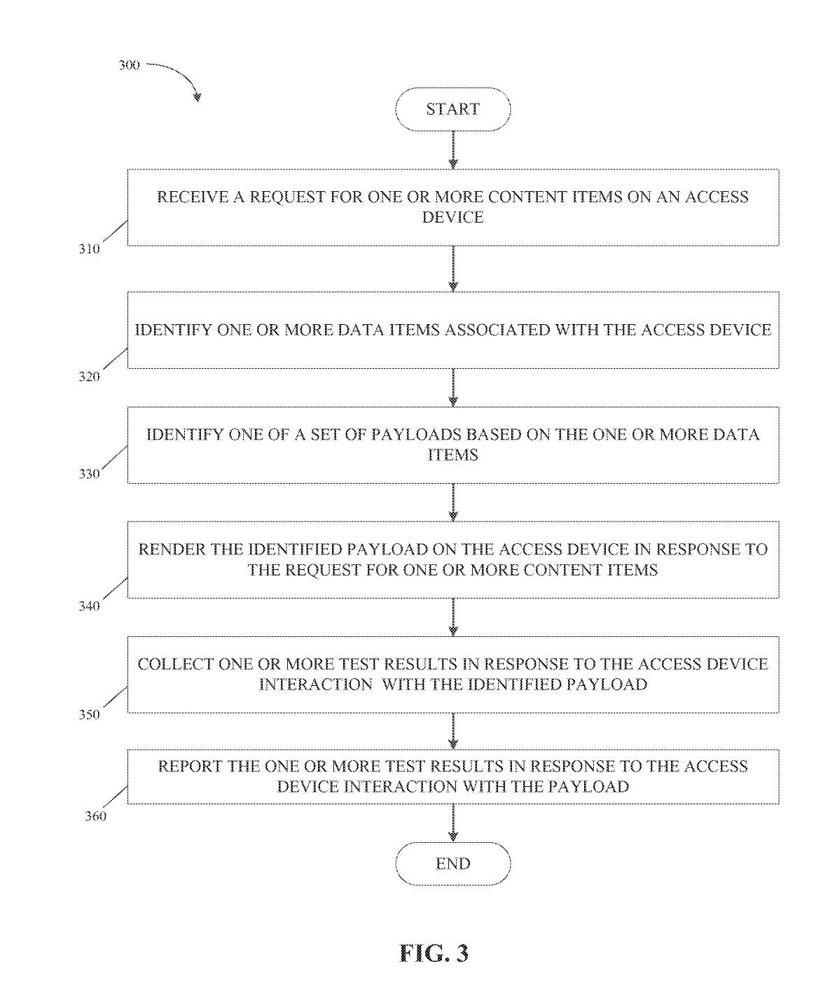

Turning now to FIG. 2, an exemplary method 200 for generating one or more payloads for multivariate testing of mobile applications is disclosed. In the exemplary embodiment illustrated in FIG. 3, the administrator module 122 is used to generate one or more applications each having an embedded SDK executable, step 210. As discussed previously, an SDK executable, embedded within the application, is executed during run time of the application and is written in the natural language of the application in which it is embedded within. According to one embodiment, the application that is generated is a mobile application for use on mobile devices, such as a smartphone or tablet device and the SDK may be written in Java for Android™ platform, Objective C for IOS® and Microsoft® .NET for Microsoft® Windows Phone® or in JavaScript for supported web-based applications.

At step 220, the administrator module 122 is used to generate a plurality of alternate payloads for each of the one or more applications. According to one embodiment, a payload is a content item. A content item includes any digital content, as is known in the art, made available over a private network, such as a private intranet, or public network, such as the Internet. Exemplary content items, include, but are not limited to, web pages and their associated content, mobile applicants and data accessed within and through the mobile application, digital advertisements, electronic mail messages and attachments, digital audio files, digital images, digitals videos, digital documents and the like. In the exemplary embodiment, the plurality of alternate payloads include a set of content items that each can be presented when rendering a mobile application.

Next at step 230, the administrator module 122 is used to associate each of the plurality of alternate payloads to one or more data items associated with an access device, such as access device 160. As will be discussed in relation to FIG. 3, a data item associated with the access device 160 can include a data item relating to the access device 160 itself, such as its orientation or screen size, and a data item relating to the environment of the access device 160, such as its location or whether its microphone is being used to accept an audio input. For example, a given payload may be configured to be associated with an access device that has an active cellular network connection to a CDMA network that has it viewing orientation in landscape mode.

At step 240, the administrator module 122 generates a configuration file for each of the one or more applications. Each application may be associated with a corresponding plurality of alternate payloads and each of the alternate payloads may be associated with one or more data items associated with an access device. For example, in one embodiment, a configuration file is generated that identifies a mobile application for a smartphone, such as a shopping application that includes a store locator function; associated alternate payloads, which may include map content from the different mobile map provides, e.g. Google Maps™ Microsoft® Bing® and Apple® Maps; and the one or more data items items associated with each alternate payload, such as the device type, network connection, network status and device location.

At step 250, using the administrator module 122, a default payload and one or more test payloads are identified for each of the one or more applications. Each of the one or more applications are then updated to include the identified default payload and the configuration file for each of the one or more applications is to identify the one or more test payloads, step 260. Continuing from the previous example, the administrator module 122 may be used to update shopping application with map content from Google Maps™ as the default payload and the configuration file to identify map content from Microsoft® Bing® and Apple® Maps as the test payload.

A data repository, such as data store 130, is populated by the administrator module 122 with the one or more applications, the plurality of alternate payloads and the associated configuration file for each of the one or more applications, step 270. According to one embodiment, the one or more applications are stored in the application data store 138, the plurality of alternate payloads is stored in the plurality data store 136 and the configuration file is stored in the configuration data store 132. Continuing from the previous example, the configuration file stores an identification of (i) the shopping application, that includes a store locator function, (ii) different mobile map providers, Google Maps™, Microsoft® Bing® and Apple® Maps and (iii) map content from Google Maps™ as the default payload and map content from Microsoft® Bing® and Apple® Maps as the test payloads, is populated in the configuration data store 132 of the data store 130. Similarly, the shopping application, that includes a store locator function, is stored in the application data store 138 and the alternate payloads in the of links to map content from the different mobile map provides, e.g. Google Maps™, Microsoft® Bing® and Apple® Maps are stored in the payload data store 136. According to one embodiment, links to the payload content are stored in the payload data store 136. In another embodiment, the payload content itself is stored in the payload data store 136. In yet another embodiment, a combination of the payload content itself and links to the payload content are stored in the payload data store 136.

Turning now to FIG. 3, an exemplary method 300 for multivariate testing of mobile applications is disclosed. In the exemplary embodiment illustrated in FIG. 3, the application module 162 of the access device 160 receives a request for one or more content items via the user interface 166, step 310. For example, a user may submit a request for a content item on his smartphone. A content item may include any digital content, as is known in the art, made available over a private network, such as a private intranet, or public network, such as the Internet. Exemplary content items, include, but are not limited to, web pages and their associated content, mobile applicants and data accessed within and through the mobile application, digital advertisements, electronic mail messages and attachments, digital audio files, digital images, digitals videos, digital documents and the like. In the exemplary embodiment, the one or more content items include data accessed and requested, including any web content, advertisements, images, video, audio and documents, within and via a mobile application. For example, the application may be a shopping application that includes a physical store locator function, and the content item requested is a set of directions from the user's home to the closest brick and mortar store.

At step 320, one or more data items associated with the access device 160 are identified by the SDK 162A. According to one embodiment, the access device 160 is a mobile device, such as a smartphone or tablet, wherein the data items are collected by the SDK 162A through one or more sensors integrated within the access device 160. Exemplary sensors, include but are not limited to audio inputs (such as a microphone), image/video inputs (such as its or camera(s)), light sensor, accelerometer, biometric sensors (such as a fingerprint scanner), environmental sensors (such as pressure, temperature and humidity sensors), gyroscopes, magnetometers, touch screen sensors, network position sensors (GPS, Wi-Fi, Bluetooth, GSM/CDMA) and proximity sensors.

Data items associated with the access device 160, in one embodiment, take a variety of forms and can be broadly categorized as data items relating to the access device 160 itself and data items relating to the environment of the access device 160. For example, data items relating to the access device 160 itself include device manufacturer, device model, device type, device orientation, device display size, device display brightness, device display text size and device battery level. Exemplary data items relating to the environment of the access device 160 include audio input, image/video input, brightness/light sensitivity, biometric inputs (e.g., fingerprints and retinal scan inputs), gravitational force measurements, ambient humidity, ambient temperature, ambient pressure, location, magnetic field, network connection status, network connection type, position, proximity and data and time zone of the location of the access device. The aforementioned data items are intended to be a comprehensive list of exemplary data items, but are not intended to be an exhaustive list limiting the number or type of data items that are collected.

Table 1, presented herein, provides an exemplary list of mobile device sensors and the data items collected.

TABLE 1
Exemplary List of Sensors and Data Items Collected

| Data Item | Sensor Type | Modes | Applicable Information |
|---|---|---|---|
| Audio input | Microphone | On/Off | Device can accept audio input via |
| | | | built-in or external microphone |
| Battery level | Battery gauge | Automatic | Device can react to stimuli/deliver |
| | | | information (or not) depending on |
| | | | amount of battery remaining (e.g. |
| | | | don't deliver video streams if capacity |
| | | | remaining is less than 20% and not on |
| | | | charger). |
| Brightness | Light sensor | Auto/Manual | Device can either manually have |
| | | | display brightness set or can use |
| | | | sensor to adjust screen brightness |
| | | | automatically |
| Date | Month/Day/Year | Automatic | Device can react to stimuli/deliver |
| | | | information (or not) depending on day |
| | | | of week (e.g. weekdays versus |
| | | | weekends) or specific days for display |
| | | | (e.g. every Monday) |
| Device | N/A | Manufacturer | Device can react to stimuli/deliver |
| Manufacturer | | information | information (or not) |
| Device Model | N/A | Manufacturer | Device can react to stimuli/deliver |
| | | information | information (or not) |
| Device | Accelerometer | Portrait/land- | Returns the orientation of the device— |
| Orientation | | scape/face | portrait or landscape mode, face up or |
| | | up/face down | face down |
| Device Type | N/A | Device form | Device model such as phone, tablet, |
| | | factor | computer, etc. |
| Display Size | N/A | Fixed | Device can react to stimuli/deliver |
| | | | information (or not) depending on |
| | | | display size (e.g. one content set for a |
| | | | tablet versus a phone versus a small |
| | | | wearable screen) |
| Fingerprint | Biometric | Present/not | Device can react to stimuli/deliver |
| | | present | information (or not) depending on |
| | | | whether a valid fingerprint swipe has |
| | | | been made |
| Gravity | Environmental— | Motion | Device can react to shake/tilt as |
| | Gravity | detection | examples |
| Humidity | Environmental | Relative | Relative humidity surrounding device |
| | | humidity | can affect screen display and device |
| | | | will react to stimuli/deliver |
| | | | information |
| Image/video | Camera | On/Off | Device can accept image/video input |
| input | | | via built-in or external camera |
| Location | Cell ID | Variable by | Devices, when connected to a mobile |
| | | network | phone network, access a network |
| | | connection | tower that has a unique cell ID. |
| | | | Rough user location can be derived |
| Location | GPS | On/Off | On and locked to GPS provides |
| | | | latitude/longitude information |
| Location | IP address | Connected/Not | Location can often (though not |
| | | connected | w/100% accuracy) be derived from IP |
| | | | address of access |
| Location | Beacon | Connected/Not | Device can detect beacon (typically |
| | | connected | via Bluetooth) to display hyper |
| | | | localized content/information |
| Magnetic | Environmental | Compass | Direction device is pointed in |
| field | | setting | |
| Network | Bluetooth | On/Off | Device connected or not via Bluetooth |
| | | | to other devices |
| Network | Mobile | On/Off | Device connected or not to mobile |
| | | | phone network |
| Network | N/A | Network | If connected to network(s), provider |
| | | Provider | information |
| Network | Near Field | On/Off | Device connected or not via NFC to |
| | Communication | | other devices |
| Network | Wi-Fi | On/Off | Device connected or not to mobile |
| | | | phone network |
| Position | Gyroscope | Variable x/y/z | Three axis gyroscope provides |
| | | | positioning of device |
| Pressure | Environmental | Barometric | Barometric pressure surrounding |
| | | pressure | device |
| Proximity | Proximity sensor | Close/away | Can be used for changing onscreen |
| | | | behavior depending on device being |
| | | | held close to or away from the face |
| Retina | Biometric | Present/not | Device can react to stimuli/deliver |
| | | present | information (or not) depending on |
| | | | whether a valid retina scan has been |
| | | | made |
| Temperature | Environmental | Ambient | Ambient temperature surrounding |
| | | temperature | device |
| Text Size | N/A | Variable | Device can display text in varying |
| | | | sizes |
| Time | Hour/Minute/ | Automatic | Device can react to stimuli/deliver |
| | Second | | information (or not) depending on |
| | | | time of day (e.g. work hours) or |
| | | | specific times for display (e.g. every |
| | | | day at 10:00 AM) |

The list of sensors and collected data items presented in Table 1 sets forth a comprehensive list of sensors that may be available on the access device 160, which according to one embodiment, may take the form factor of a mobile device, along with the corresponding sensor modes and the data items collected. For example, the access device 160's accelerometer can be used to determine the orientation of the device, i.e. whether the access device 160 is oriented in a portrait or landscape mode and whether the access device 160 is being held face up or face down. In another example, the access device 160's microphone can be used to determine whether the existence and level of ambient noise.

Returning to FIG. 3, and continuing from the previous example wherein the application is a shopping application that includes a physical store locator function, and the content item requested is a set of directions from the user's home to the closest brick and mortar store, at step 320, the SDK 162A embedded in the shopping application may identify the following data items regarding an exemplary mobile access device: (a) Device type: Galaxy S5, (b) Device manufacturer: Samsung, (c) Network connection: AT&T Wireless, (d) Network connection: AT&T Public Wi-Fi, (e) Time of day: 10:13 AM EDT, (f) Date: Thursday, 17 Apr. 2014, (g) Viewing mode: Portrait, (h) Ambient Lighting: Sunny/Bright and (i) Location: 33.928 latitude/−84.340 longitude (115 Perimeter Center P1). Further, the SDK 162A may identify the following data items regarding an exemplary second mobile access device: (a) Device type: iPad Air, (b) Device manufacturer: Apple, (c) Network connection: Verizon Wireless, (d) Time of day: 10:13 AM EDT, (e) Date: Thursday, 17 Apr. 2014, (f) Viewing mode: Landscape, (g) Ambient lighting: Office, (h) Location: 33.928 latitude/−84.340 longitude (115 Perimeter Center P1)

At step 330, one of a plurality of payloads is identified by the testing module 126 based on the one or more data items. According to one embodiment, the testing module 126 receives the one or more data items over the network 170 from the SDK 162A, which the testing module 126 will in turn use in conjunction with the appropriate configuration file stored in configuration data store 132 in order to identify the appropriate payloads or links to payloads stored in the payload data store 136. Continuing from the previous example, the testing module 126 having received the following data items for the exemplary mobile access device: (a) Device type: Galaxy S5, (b) Device manufacturer: Samsung, (c) Network connection: AT&T Wireless, (d) Network connection: AT&T Public Wi-Fi, (e) Time of day: 10:13 AM EDT, (f) Date: Thursday, 17 Apr. 2014, (g) Viewing mode: Portrait, (h) Ambient Lighting: Sunny/Bright and (i) Location: 33.928 latitude/−84.340 longitude (115 Perimeter Center P1), identifies the payload as map content from Microsoft® Bing® based on the fact that AT&T's map provider is Bing® based on the configuration file and accordingly finds the appropriate link in the payload data store 126 to Bing®. In one embodiment, the identified payload comprises, in addition to the content item itself, any adjustments necessary to optimize the content item for the access device which the application is running on, which is undertaken by the testing module 126. Continuing from the previous example, the payload will include map content from Bing® that appropriately fits a Samsung Galaxy S5 in landscape mode AND automatically adjusts fonts, colors, and method of map display to compensate for sunny/bright conditions as dictated by light sensor.

According to one embodiment, the testing module 126 makes any adjustments to the payload in order to generate alternate payloads for purposes of performing testing on alternate payloads presented to a user. Examples of adjustments made to generate alternate payloads include, but are not limited to: (i) label switch, i.e. changing the text of a label, (ii) image switch, (iii) button modification, i.e., changing label, positioning and/or color of a button, (iv) pop-up modification, i.e., changing the text or positioning of a popup and (v) animation modification, i.e., changing the way or timing that information is presented to the user.

Returning to FIG. 3, the identified payload is transmitted to the SDK 162A and cached to internal storage 164 of the access device 160. The identified payload is then rendered by the SDK 162A on the user interface 166 of the access device 160 in response to the request for the one or more content items, step 340. For example, where the identified payload is map content from Bing® that appropriately fits a Samsung Galaxy S5 in landscape mode and automatically adjusts fonts, colors, and method of map display to compensate for sunny/bright conditions as dictated by light sensor, the payload is downloaded by the SDK 162A, stored in internal storage 164 and rendered within in the shopping application on the user interface 166.

At step 350, one or more test results are collected by the SDK 162A in response to the access device 160 interaction with the identified payload. For example, all user interaction with the mobile application is monitored and collected by the SDK 162A, such as whether the user engaged in a click-through, how long the user observed the display, whether the user accessed a link to other content, whether the user engaged is the selection of any radio buttons or drop down menus on the display. Further, according to one embodiment, the conditions under which the user interacted with the identified payload is monitored and recorded. Examples of such conditions, include but are not limited to, the geographic location of the access device, the strength of the network connection for the access device, demographic information regarding the user and environmental conditions of the access device.

The one or more test results are then reported by the SDK 162A to the reporting module 124 in response to the access device 160 interaction with the identified payload, and subsequently stored in the reporting data store 134, step 360. For example, test results regarding whether the user engaged in a click-through or how long the user observed the display are asynchronously transmitted from the SDK 162A to the reporting module 124 and subsequently stored in the reporting data store 134. According to one embodiment, the one or more test results stored in the reporting data store 134 are made accessible to the reporting device 150 through a web application executed by the application module 152 via the reporting module 124.

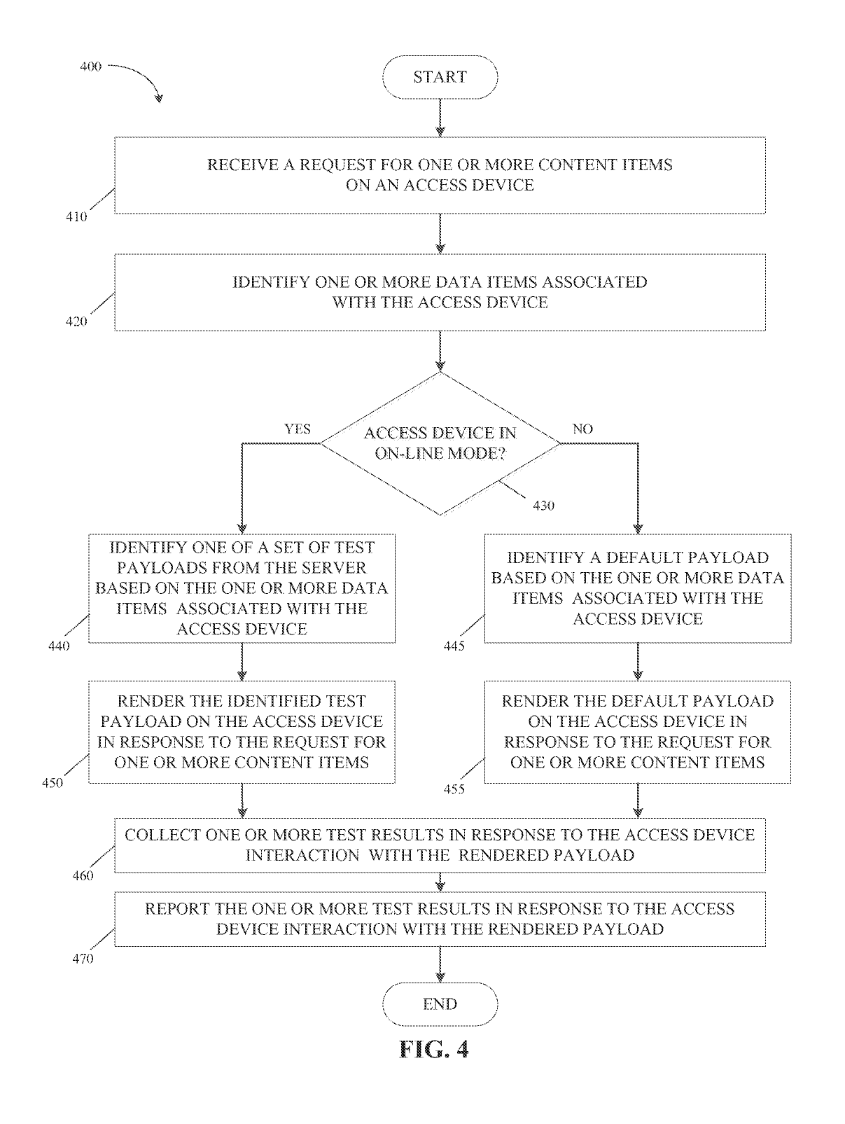

Turning now to FIG. 4, an exemplary method 400 for multivariate testing of mobile applications is disclosed. In the illustrated embodiment shown in FIG. 4, the application module 162 of the access device 160 receives a request for one or more content items via the user interface 166, step 410. As discussed previously, a content item includes any digital content, as is known in the art, made available over a private network or public network, such as web pages and their associated content, mobile applicants and data accessed within and through the mobile application, digital advertisements, electronic mail messages and attachments, digital audio files, digital images, digitals videos, digital documents and the like. In the exemplary embodiment, the one or more content items include data accessed and requested, including any web content, advertisements, images, video, audio and documents, within and via a mobile application.

At step 420, one or more data items associated with the access device 160 are identified by the SDK 162A. As discussed previously in connection with FIG. 3, data items associated with the access device 160, in one embodiment, take a variety of forms and can be broadly categorized as data items relating to the access device 160 itself and data items relating to the environment of the access device 160.

Referring back to FIG. 4, according to one embodiment, a determination is then made as to whether the access device 160 is in an on-line mode and connected to the network 170, step 430. According to one embodiment, the SDK 162A makes a determination as to whether the access device 160 is connected to the network 170 through analysis of one or more data items collected relating to the network connection of the access device 160. For example, a determination is made by the SDK 162A as to whether the access device 160 is connected to a cellular or Wi-Fi network.

If the access device 160 is determined to be in an on-line mode, one of a set of test payloads is identified based on the one or more data items associated with the access device, step 440. According to one embodiment, the testing module 126 receives the one or more data items over the network 170 from the SDK 162A, which the testing module 126 will in turn use in conjunction with the appropriate configuration file stored in configuration data store 132 in order to identify the appropriate payloads or links to payloads stored in the payload data store 136. Continuing from a previous example, the testing module 126 having received the following data items for access device 160: (a) Device type: Galaxy S5, (b) Device manufacturer: Samsung, (c) Network connection: AT&T Wireless, (d) Network connection: AT&T Public Wi-Fi, (e) Time of day: 10:13 AM EDT, (f) Date: Thursday, 17 Apr. 2014, (g) Viewing mode: Portrait, (h) Ambient Lighting: Sunny/Bright and (i) Location: 33.928 latitude/−84.340 longitude (115 Perimeter Center P1), identifies the test payload from a set of test payloads as map content from Microsoft® Bing® based on the fact that AT&T's map provider is Bing® using the configuration file stored in the configuration data store 132 and accordingly finds the appropriate link in the payload data store 126 to Bing®. The identified payload is rendered on the access device 160 in response to the request for the content item, step 450.

Alternatively, if the access device 160 is determined to be in an off-line mode and not connected to the network 170, at step 455, a default payload is identified based on the one or more data items associated with the access device 160. Continuing from a previous example, the SDK 162A having identified the following data items for access device 160: (a) Device type: Galaxy S5, (b) Device manufacturer: Samsung, (c) Network connection: NA, (e) Time of day: 10:13 AM EDT, (f) Date: Thursday, 17 Apr. 2014, (g) Viewing mode: Portrait, (h) Ambient Lighting: Sunny/Bright and (i) Location: NA, determines that the access device 160 is in an off-line mode as it does not recognize a network connection. Accordingly, the SDK 162A identifies the appropriate default payload from internal storage 164 based on the one or more data items associated with the access device 160. According to one embodiment, when the application is initially installed on the access device 160, the installation will include one or more default payloads that are stored in internal storage 163 as set initially determined by the administrator module 122. Continuing from our previous example, SDK 162A having identified the following data items for access device 160: (a) Device type: Galaxy S5, (b) Device manufacturer: Samsung, (c) Network connection: NA, (e) Time of day: 10:13 AM EDT, (f) Date: Thursday, 17 Apr. 2014, (g) Viewing mode: Portrait, (h) Ambient Lighting: Sunny/Bright and (i) Location: NA, selects the default payload from internal storage 164 that appropriately fits the display area of the Samsung Galaxy S5 in portrait viewing mode, in this case map content from Google Maps™ formatted for the Galaxy S5. In step 455, the default payload is then rendered on the access device 160 in response to the request for the content item.

Next, at step 460, one or more test results in response to the interaction between the access device 160 and the rendered payload are collected. For example, all user interaction with the mobile application is monitored and collected by the SDK 162A, such as whether the user engaged in a click-through, how long the user observed the display, whether the user accessed a link to other content, whether the user engaged is the selection of any radio buttons or drop down menus on the display. Further, according to one embodiment, the conditions under which the user interacted with the identified payload is monitored and recorded by the SDK 162A. Examples of such conditions, include but are not limited to, the status of the network connection for the access device, demographic information regarding the user and environmental conditions of the access device.

The one or more test results are then reported by the SDK 162A to the reporting module 124 in response to the access device 160 interaction with the identified payload, and subsequently stored in the reporting data store 134, step 470, when the access device 160 is an on-line mode and connected to the network 170. According to one embodiment, as shown in step 430, if it is determined that the access device is in an off-line mode, the SDK 162A maintains the one or more test results in internal storage 164 until the access device 160 is connected to network 170, at which time the SDK 162A reports the test results to reporting module 124.

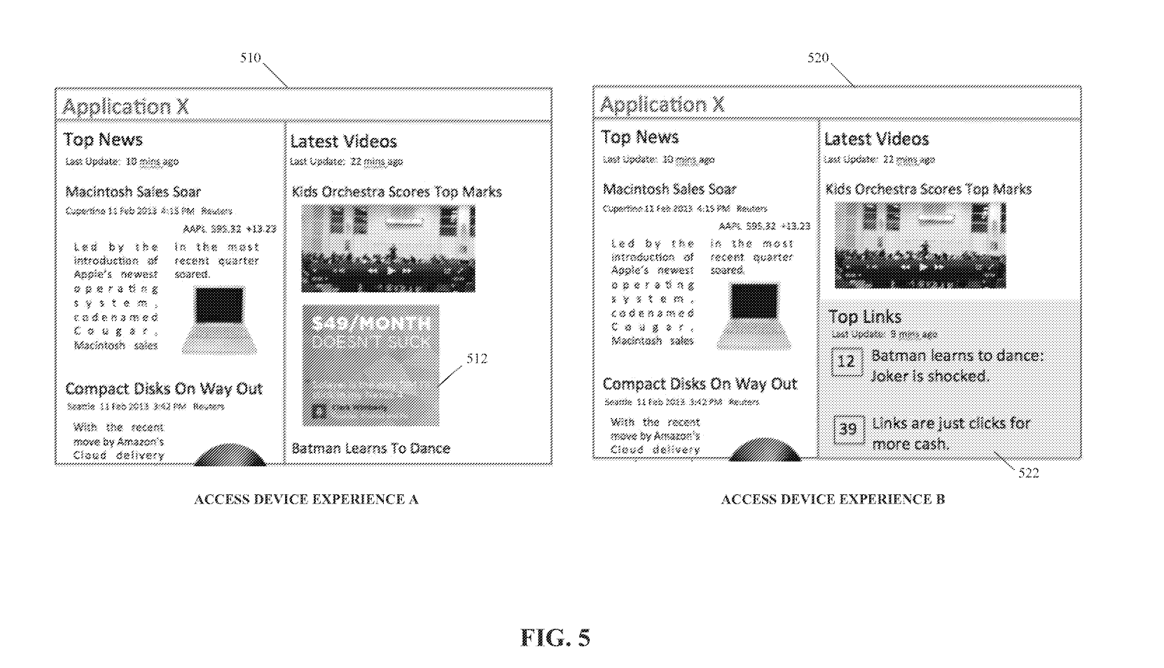

Turning now to FIG. 5, a screen diagram of an exemplary multivariate testing of a mobile application is illustrated. Screen shot 510 of Application X demonstrates Access Device Experience A and screen shot 512 demonstrates Access Device Experience B. In comparing screen shots 510 and 512, the notable difference between the two customer experiences is the inclusion of advertisement 512 in Access Device Experience A as compared to a listing of top links 522 in Access Device Experience A. The interaction with the respective user of each access device experience, e.g. the click through rate of the advertisement 512 or one of the URL links of 522, is recorded by the SDK 162A of system 100 and ultimately reported to reporting device 150 via the reporting module 124 of the server device 110

FIGS. 1 through 5 are conceptual illustrations allowing for an explanation of the present disclosure. It should be understood that various aspects of the embodiments of the present disclosure may be implemented in hardware, firmware, software, or combinations thereof. In such embodiments, the various components and/or steps may be implemented in hardware, firmware, and/or software to perform the functions of the present disclosure. That is, the same piece of hardware, firmware, or module of software may perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the disclosure as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific embodiments so fully reveals the general nature of the disclosure that others can, by applying knowledge within the skill of the relevant art(s) (including the contents of the documents cited and incorporated by reference herein), readily modify and/or adapt for various applications such specific embodiments, without undue experimentation, without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of example, and not limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A computer-implemented method for multivariate testing, the method comprising:
in response to a request for one or more content items on an access device, identifying one or more data items associated with the access device;
identifying one of a set of payloads based on the one or more data items associated with the access device;
retrieving the identified payload; and
rendering the identified payload on the access device.

2. The computer-implemented method of claim 1, further comprising collecting one or more test results in response to an interaction with the access device.

3. The computer-implemented method of claim 1, further comprising determining whether the access device is in an on-line mode or an off-line mode.

4. The computer-implemented method of claim 3, wherein the access device is in an on-line mode and the set of payloads further comprises one or more test payloads.

5. The computer-implemented method of claim 3, wherein the access device is in an off-line mode and the set of payloads further comprises one or more default payloads.

6. The computer-implemented method of claim 4, wherein retrieving the identified payload further comprises retrieving an identified test payload from a remote server.

7. The computer-implemented method of claim 5, wherein retrieving the identified payload further comprises retrieving an identified default payload from the access device.

8. The computer-implemented method of claim 1, wherein the one or more data items associated with the access device are collected from one or more sensors of the access device.

9. The computer-implemented method of claim 1, wherein the one or more data items associated with the access device comprise at least one of: access device type, access device manufacturer, access device model, network connection type, date, time, access device orientation, access device location, access device display size, access device position, ambient temperature, ambient lighting, ambient humidity, ambient pressure, battery level, audio input capability, image/video input capability, device brightness, magnetic field, display text size, and biometric capability.

10. Non-transitory computer readable media comprising program code stored thereon for execution by a programmable processor to perform a method for multivariate testing, the computer readable media comprising:
in response to a request for one or more content items on an access device, program code for identifying one or more data items associated with the access device;
program code for identifying one of a set of payloads based on the one or more data items associated with the access device;
program code for retrieving the identified payload; and
program code for rendering the identified payload on the access device.

11. The computer readable media of claim 10, further comprising program code for collecting one or more test results in response to an interaction with the access device.

12. The computer readable media of claim 10, further comprising program code for determining whether the access device is in an on-line mode or an off-line mode.

13. The computer readable media of claim 12, wherein the access device is in an on-line mode and the set of payloads further comprises one or more test payloads.

14. The computer readable media of claim 12, wherein the access device is in an off-line mode the set of payloads further comprises one or more default payloads.

15. The computer readable media of claim 13, wherein the program code for retrieving the identified payload further comprises program code for retrieving an identified test payload from a remote server.

16. The computer readable media of claim 14, wherein the program code for retrieving the identified payload further comprises program code for retrieving an identified default payload from the access device.

17. The computer readable media of claim 10, wherein the one or more data items associated with the access device are collected from one or more sensors of the access device.

18. The computer readable media of claim 10, wherein the one or more data items associated with the access device comprise at least one of: access device type, access device manufacturer, access device model, network connection type, date, time, access device orientation, access device location, access device display size, access device position, ambient temperature, ambient lighting, ambient humidity, ambient pressure, battery level, audio input capability, image/video input capability, device brightness, magnetic field, display text size, and biometric capability.

19. A system for multivariate testing, the method comprising:
a server including a processor and memory storing instructions that, in response to receiving request for one or more content items on an access device, cause the processor to:
identify one or more data items associated with the access device;
identify one of a set of payloads based on the one or more data items associated with the access device;
retrieve the identified payload; and
render the identified payload on the access device.

20. The system of claim 20, wherein the processor further collects one or more test results in response to an interaction with the access device.

21. The system of claim 20, wherein the processor further determines whether the access device is in an on-line mode or an off-line mode.

22. The system of claim 21, wherein the access device is in an on-line mode and the set of payloads further comprises one or more test payloads.

23. The system of claim 21, wherein the access device is in an off-line mode and the set of payloads further comprises one or more default payloads.

24. The system of claim 22, wherein the processor further retrieves the identified payload further comprises retrieving an identified test payload from a remote server.

25. The system of claim 23, wherein the processor further retrieves the identified payload further comprises retrieving an identified default payload from the access device.

26. The system of claim 20, wherein the one or more data items associated with the access device are collected from one or more sensors of the access device.

27. The system of claim 20, wherein the one or more data items associated with the access device comprise at least one of: access device type, access device manufacturer, access device model, network connection type, date, time, access device orientation, access device location, access device display size, access device position, ambient temperature, ambient lighting, ambient humidity, ambient pressure, battery level, audio input capability, image/video input capability, device brightness, magnetic field, display text size, and biometric capability.
